(19) United States
(12) Patent Application Publication
(10) Pub. No.: US 2015/0046943 A1
(43) Pub. Date: Feb. 12, 2015

(54) AUTOMATIC SWITCHING FROM PRIMARY TO SECONDARY AUDIO DURING EMERGENCY BROADCAST

(71) Applicant: Sony Corporation, Tokyo (JP)

(72) Inventors: Peter Shintani, San Diego, CA (US); Robert Noel Blanchard, Escondido, CA (US)

(73) Assignee: Sony Corporation, Tokyo (JP)

(21) Appl. No.: 13/964,644

(22) Filed: Aug. 12, 2013

(51) Int. Cl. H04N 21/81; H04N 21/44; H04N 21/488; H04N 21/439

(52) U.S. Cl. CPC H04N 21/814; H04N 21/439; H04N 21/44; H04N 21/4886
USPC 725/33

(57) ABSTRACT

An audio video display device (AVDD) includes a display, a processor controlling the display and a computer readable storage medium that is accessible to the processor. The computer readable storage medium bears instructions which when executed by the processor cause the processor to present, on the AVDD, AV content that is not associated with information pertaining to an emergency. The instructions cause the processor to receive, at the AVDD, data associated with an emergency alert and, responsive to receiving the data associated with the emergency alert, change audio presented on the AVDD from first audio presented on the AVDD and associated with the AV content to second audio associated the data to present the second audio. The second audio is presented on the AVDD automatically without receiving user input to change from the first audio to the second audio subsequent to receiving the data associated with the emergency alert.

### I. FIELD OF THE INVENTION

The present application relates generally to providing emergency alerts for the visually impaired on consumer electronics (CE) devices.

### II. BACKGROUND OF THE INVENTION

Emergency alerts are often broadcasted to people to warn them of current or imminent hazardous conditions, such as severe storms, flooding, fires, tornados, excessive heat, etc. These emergency alerts are often caused to be presented on or by a device when the device is, e.g., powered on and tuned to a TV channel, and hence the emergency alert provider is able to use the TV channel as a medium through which to the convey information. Rather than completely interrupting “regularly scheduled programming” with a special audio video programming alert (e.g., a special news telecast), emergency alerts are sometimes visually presented in the form of text, e.g., on at the bottom of the display associated with the device while the “regularly scheduled programming” continues to be presented both visually and audibly.

### SUMMARY OF THE INVENTION

Present principles recognize that the visually impaired may find it difficult to read emergency information text provided on the display along with regularly scheduled audio video (AV) content, and hence systems, devices, and methods are provided for conveniently accessing and/or changing to an audio stream on the user's device to listen to the emergency information audibly. Accordingly, a device includes a processor configured for controlling a display such as a video and/or audio display, and at least one computer readable storage medium that is not a carrier wave and that is accessible to the processor. The computer readable storage medium bearing instructions which when executed by the processor cause the processor to present, on the display, audio video (AV) content that is not associated information pertaining to a current emergency or imminent emergency. The instructions also cause the processor to receive data associated with an emergency alert and, responsive to receiving the data associated with the emergency alert, change audio presented on the display from first audio presented on the display and associated with the AV content to second audio associated the data associated with the emergency alert to thereby present the second audio. The second audio is understood to be presented on the display automatically without receiving user input to change from the first audio to the second audio subsequent to receiving the data associated with the emergency alert. If desired, an aural tone that indicates emergency information will be presented on the display may be included in the second audio.

Furthermore, in some embodiments the AV content may even be presented on the display subsequent to changing to the second audio such as video of the AV content and, e.g., responsive to receiving the data associated with the emergency alert, the emergency information associated with the emergency alert may be overlaid on the video. For instance, the emergency information may be presented as text scrolling across a portion of the display as video of the AV content is also presented.

Also in some embodiments, the data may include both audio data for presenting the second audio on the display and metadata which, when received by the display, at least in part causes the processor to change to the second audio. Even further, the audio may be changed in exemplary embodiments to the second audio responsive to receiving the data associated with the emergency alert only if, prior to receiving the data, a setting associated with the display to change to the second audio upon receiving data associated with an emergency alert has been set to active.

In another aspect, a method includes presenting, on a consumer electronics (CE) device, audio video (AV) content that is not associated with information pertaining to an emergency and then receiving data pertaining to a current emergency or imminent emergency. The method also includes visually presenting on the CE device a visual indication that information regarding an emergency is available responsive to a determination that the data does not include data for causing an audio indication of the emergency to be presented on the CE device. Furthermore, the method includes audibly presenting the audio indication on the CE device at least in part using the received data responsive to a determination that the data includes data for causing an audio indication of the emergency to be presented on the CE device.

In yet another aspect, a computer readable storage medium includes instructions which when executed by a processor of a device configure the processor to execute logic including presenting audio video (AV) content on a display controlled by the processor that pertains to a current or imminent emergency, receiving first data at the device including at least information for visual overlay on at least a portion of the video of the AV content, and converting the first data into second data useful for audio presentation of the information. The information for visual overlay is understood to pertain to a current or imminent emergency.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an exemplary system including a device in accordance with present principles;

FIGS. 2 and 3 an exemplary flowchart of logic to be executed by a device to present emergency alerts and/or information in accordance with present principles;

FIG. 4 is an exemplary flowchart of logic to be executed by a server for providing emergency alerts and/or information to one or more devices in accordance with present principles;

FIGS. 5-11 are exemplary user interfaces (UIs) for providing emergency alerts and/or information in accordance with present principles; and

FIG. 12 is an exemplary settings UI for a device that includes at least one visually impaired setting that is configurable by a user of the device.

### DETAILED DESCRIPTION OF THE PREFERRED EMBODIMENT

Disclosed are methods, apparatus, and systems for devices, including navigation devices such as set-top boxes that control audio video display devices including video displays and/or speakers, and also including consumer electronics (CE) devices. The navigation devices of 47 U.S.C. §629, incorporated herein by reference, are intended to be included within the scope of the claims.

A system herein may include server and client components, connected over a network such that data may be exchanged between the client and server components. The client components may include one or more computing devices. These may include televisions (e.g. computerized TVs, Internet-enabled TVs, and/or high definition (HD) TVs), personal computers, laptops, tablet computers, and other mobile devices including computerized phones, navigation devices. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the Internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below.

The technology is operational with numerous other general purpose or special purpose computing system environments or configurations. Examples of well-known computing systems, environments, and/or configurations that may be suitable for use with the invention include, but are not limited to, TVs, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®//i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated, each of the modules comprises various sub-routines, procedures, definitional statements and macros. The description of each of the software/logic/modules is used for convenience to describe the functionality of the preferred system. Thus, the processes that are undergone by each of the software/logic/modules may be arbitrarily redistributed to one of the other software/logic/modules, combined together in a single software process/logic flow/module, or made available in, for example, a shareable dynamic link library.

The system may be written in any conventional programming language such as C#,C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable storage medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as may be used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated herein, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments may be apparent. The various aspects and embodiments disclosed herein are for purposes of illustration and are not intended to be limiting.

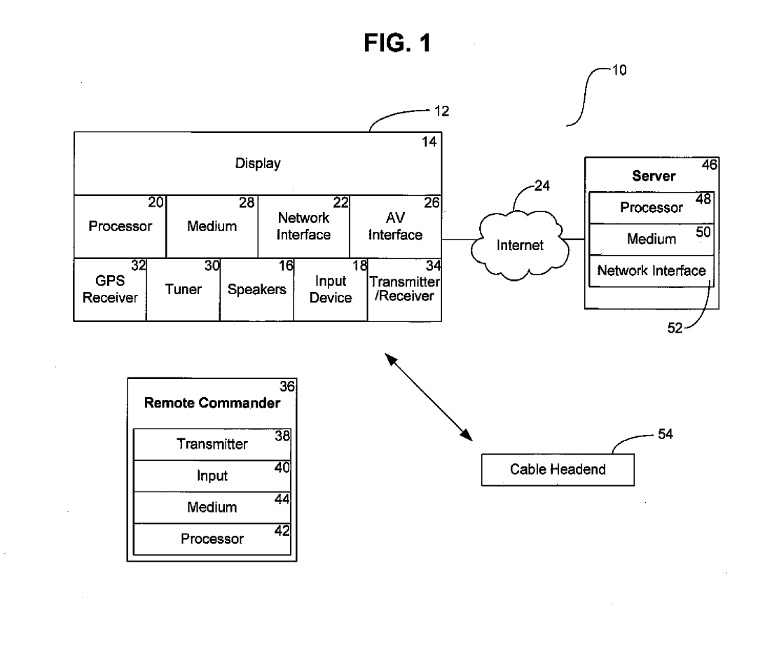

Referring now to FIG. 1, an exemplary system 10 includes at least one device 12 that in exemplary embodiments is a television (TV) such as e.g. a high definition TV and/or Internet-enabled computerized TV, and/or that is a navigation device such as a set top box that controls the audio/video displays of a device. For ease of description, the device 12 will be assumed, in the example shown herein, to be an integrated consumer electronics (CE) device. In addition to a TV the CE device 12 may be a wireless and/or mobile telephone, computerized phone (e.g., an Internet-enabled and touch-enabled mobile telephone), a laptop computer, a desktop computer, a tablet computer, a PDA, a video game console, a video player, a personal video recorder, a computerized watch, a music player, etc. Regardless, it is to be understood that the device 12 is configured to undertake present principles (e.g. to present emergency information in accordance with present principles).

Describing the example CE device 12 with more specificity, it includes a touch-enabled display 14, one or more speakers 16 for outputting audio such as audio pertaining to an emergency alert as disclosed herein, and at least one additional input device 18 such as, e.g., an audio receiver/microphone, keypad, touchpad, etc. for providing input and/or commands (e.g. audible commands) to a processor 20 for controlling the CE device 12 such as e.g. configuring visually impaired settings and/or changing audio inputs to listen to emergency information in accordance with present principles. The CE device 12 also includes a network interface 22 for communication over at least one network 24 such as the Internet, an WAN, a LAN, etc. under control of the processor 20, it being understood that the processor 20 controls the CE device 12 including presentation of emergency information as disclosed herein. Furthermore, the network interface 22 may be, e.g., a wired or wireless modem or router, or other appropriate interface such as, e.g., a wireless telephony transceiver.

In addition to the foregoing, the CE device 12 may include an audio video interface 26 such as, e.g., a USB or HDMI port for receiving input (e.g. AV content) from a component device such as e.g. a set top box or Blue Ray disc player for presentation of the content on the CE device 12, as well as a tangible computer readable storage medium 28 such as disk-based or solid state storage. The medium 28 is understood to store the software code and/or logic discussed herein for execution by the processor 20 in accordance with present principles. Further still, the CE device 12 may also include a TV tuner 30 and a GPS receiver 32 that is configured to receive geographic position information from at least one satellite and provide the information to the processor 20 to undertake present principles such as e.g. determining whether an emergency alert for a particular geographic region includes the region in which the CE device 12 is disposed and should thus be presented on the CE device 12 (e.g., responsive to a determination of being with the region for the alert by the CE device 12), though it is to be understood that another suitable position receiver other than a GPS receiver may be used in accordance with present principles.

Moreover, it is to be understood that the CE device 12 also includes a transmitter/receiver 34 for communicating with a remote commander (RC) 36 associated with the CE device 12 and configured to provide input (e.g., commands) to the CE device 12 (e.g. to the processor 20) to thus control the CE device 12. Accordingly, the RC 36 also has a transmitter/receiver 38 for communicating with the CE device 12 through the transmitter/receiver 34. The RC 36 also includes an input device 40 such as a keypad or touch screen display, as well as a processor 42 for controlling the RC 36 and a tangible computer readable storage medium 44 such as disk-based or solid state storage. Though not shown, in some embodiments the RC 36 may also include a touch-enabled display screen and a microphone that may be used for providing input/commands to the CE device 12 in accordance with present principles.

Still in reference to FIG. 1, reference is now made to a server 46 of the system 10. The server 46 includes at least one processor 48, at least one tangible computer readable storage medium 50 such as disk-based or solid state storage, and at least one network interface 52 that, under control of the processor 48, allows for communication with the CE device 12 (and even a cable head end 54 to be described shortly) over the network 24 and indeed the server 46 may facilitate communication between the CE device 12, server 46, and cable head end 54. Note that the network interface 52 may be, e.g., a wired or wireless modem or router, or other appropriate interface such as, e.g., a wireless telephony transceiver. Accordingly, in some embodiments the server 46 may be an Internet server, may facilitate the transmission of emergency alert information to the CE device 12, and may include and perform “cloud” functions such that the CE device 12 may access a “cloud” environment via the server 46 in exemplary embodiments. Additionally, note that the processors 20, 42, and 48 are configured to execute logic and/or software code as disclosed herein.

Describing the head end 54 mentioned above, it is to be understood that although the head end 54 is labeled as a cable head end in particular in FIG. 1, it may be a satellite head end as well. The head end 54 is understood to be in communication with the CE device 12 and/or server 46 over, e.g., a closed network (through a wired or wireless connection), and furthermore may itself include a network interface (not shown) such that the head end 54 may communicate with the CE device 12 and/or server 46 over a wide-area and/or open network such as the network 24. Further still, it is to be understood that the head end 54 may be wired or wirelessly connected to a non-internet server, and/or may optionally be integrated with a non-interne server. In any case, it is to be understood that the head end 54 may facilitate the transmission of emergency alert information to the CE device 12 in accordance with present principles.

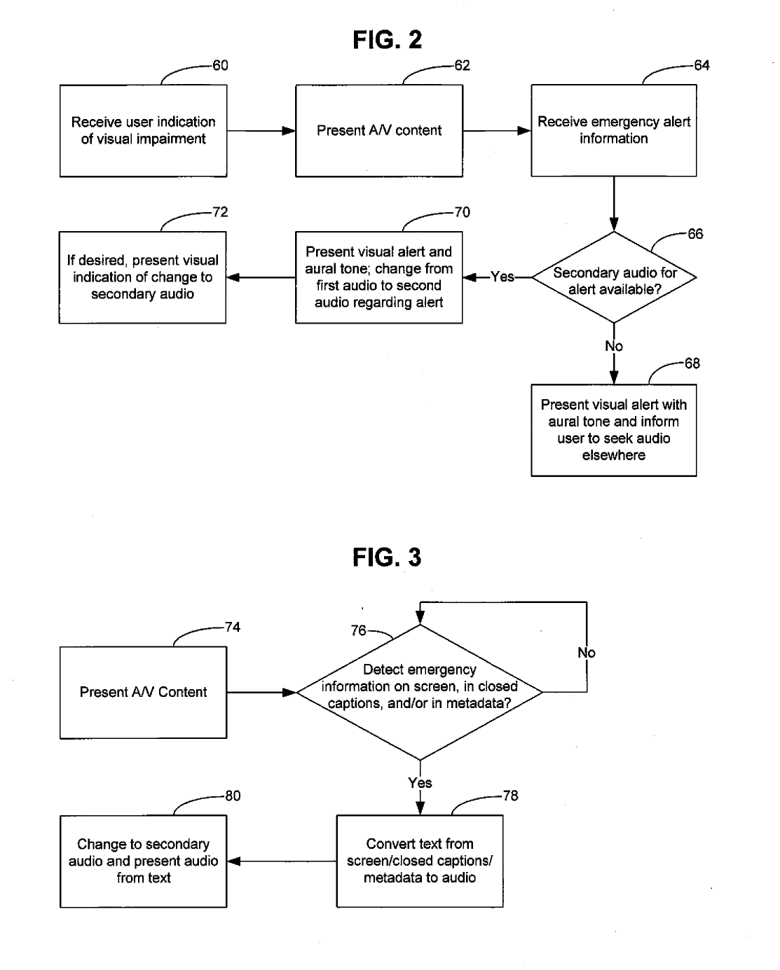

Turning now to FIG. 2, an exemplary flowchart of logic to be executed by a CE device such as the CE device 12 to present emergency alert information in accordance with present principles is shown. The logic begins at block 60 where the logic receives an indication from a user that the user has a visual impairment, which in exemplary embodiments may be received e.g. based on (user) configuration of one or more visually impaired settings of the CE device executing the logic. The visually impaired settings may simply involve e.g. presenting closed captioning in relatively larger text than a normal presentation setting, and/or amplifying volume, but in any case configuration of such settings to assist the visually impaired may be used in accordance with the currently described emergency alert principles to present emergency information based on configuration of one or more of those settings. Furthermore, an emergency alert setting in particular may be included in addition to or in lieu of the settings discussed above to configure a CE device to provide (e.g. only) emergency information to the visually impaired in accordance with present principles, and even further a “universal” visually impaired setting may be configured by a user which in turn automatically without further user input may configure one or more other CE device settings such as those described above to further assist with the presentation of content (e.g. AV content and emergency alert information) to the visually impaired.

In any case, after receiving the user indication at block 60 the logic continues to block 62 where audio video (AV) content is presented on the CE device that in exemplary embodiments does not pertain to an emergency alert and in this respect may be e.g. “regularly scheduled programming” such as a situational comedy, reality TV, a sporting event broadcast, a movie, a talk show, etc. The logic then moves to block 64 where the logic receives emergency alert information from e.g. a content provider or government agency via a server or a cable head end such as the server 46 or cable head end 54 described above.

Thereafter the logic proceeds to decision diamond 66 where the logic determines whether secondary audio for the emergency alert is available (e.g. whether audio of information regarding the emergency alert was received in the emergency alert information received at block 64). If a negative determination is made at diamond 66, the logic proceeds to block 68 where the logic either or both presents whatever emergency alert information was received, e.g. in the present exemplary case information for visual presentation and/or a visual alert that audible emergency alert information (e.g. for the geographic area in which the CE device executing the logic of FIG. 2 is located) cannot be presented at the current time. Such a visual alert may also include e.g. an indication that the emergency alert information should be sought elsewhere (e.g. using another CE device, an AM/FM radio, etc.) An aural tone indicating emergency information is currently or is about to be presented may also be provided audibly over the CE device at block 68, it being understood that the aural tone may either or both have been received with the emergency alert information at block 64 and/or may be stored locally on a storage medium of the CE device for (e.g. automatic) presentation when emergency alert information is received. The logic may thus conclude at block 68 after the negative determination at diamond 66.

However, if an affirmative determination was instead made at diamond 66, the logic instead proceeds to block 70 rather than block 68. At block 70, a visual alert containing emergency alert information received at block 64, as well as aural tone such as the aural tone described above, are presented. Also at block 70, the logic may change audio (e.g. input) from first audio to second audio (e.g. a secondary audio stream and/or secondary audio input instead of audio from the AV content). The second audio is thus provided at block 70 that includes emergency alert information presented in audible form that accordingly may be observed (e.g. audibly) by a visually impaired user of the CE device whom may not otherwise be able to discern e.g. a relatively small emergency alert visually presented on a display of the CE device executing the logic of FIG. 2. The logic may then either end at block 70 or optionally proceed to block 72 where a visual indication (e.g. in relatively large text such as taking up the entire display of the CE device and completely obscuring video of the AV content) may be presented on the display of the CE device indicating that audio presentation has been changed to the second audio/secondary audio to inform a visually impaired observer that emergency alert information is being presented so as to e.g. not confuse the user that the emergency alert information is e.g. fictional information that is a part of regularly scheduled AV content being presented but instead pertains to an actual emergency to which the user should be made aware.

Continuing the detailed description in reference to FIG. 3, another exemplary flowchart of logic to be executed by a CE device such as the CE device 12 to present emergency alert information in accordance with present principles is shown. Beginning at block 74, AV content is presented on the CE device e.g. similar to presentation of AV content as described above in reference to block 62 of FIG. 2. The logic then moves from block 74 to decision diamond 76 where the logic determines (e.g. by detecting, processing, and/or scanning) whether emergency information is being presented on the display of the CE device (e.g. has been combined with the AV content and/or superimposed/overlaid on video of the AV content) via e.g. closed captioning/closed caption data, scrolling text, and/or is included in metadata accompanying the AV content. If a negative determination is made at diamond 76, the logic may continue presenting AV content and continue making the determination of diamond 76 until such a time as an affirmative determination is made thereat.

Accordingly, upon an affirmative determination at diamond 76, the logic proceeds to block 78 where the logic e.g. converts to audio form the text and/or data that has been detected in a video portion of the AV content, overlaid on the video portion, included in closed caption information, and/or included in metadata. The logic then proceeds to block 80 where the logic changes CE device audio (e.g. input) to a second audio configuration (e.g. as set forth above in reference to block 70 of FIG. 2) and presents emergency alert information audibly that has been converted. Thus, present principles recognizes that text-to-speech software/modules and/or speech recognition technology may be used in accordance with present principles to convert data/information for visual presentation on a CE device into content to be presented audibly to thus notify a visually impaired observer of emergency information that the visually impaired observer may not otherwise notice and/or be able to discern only if visually presented (e.g. in small text on a bottom portion of the display).

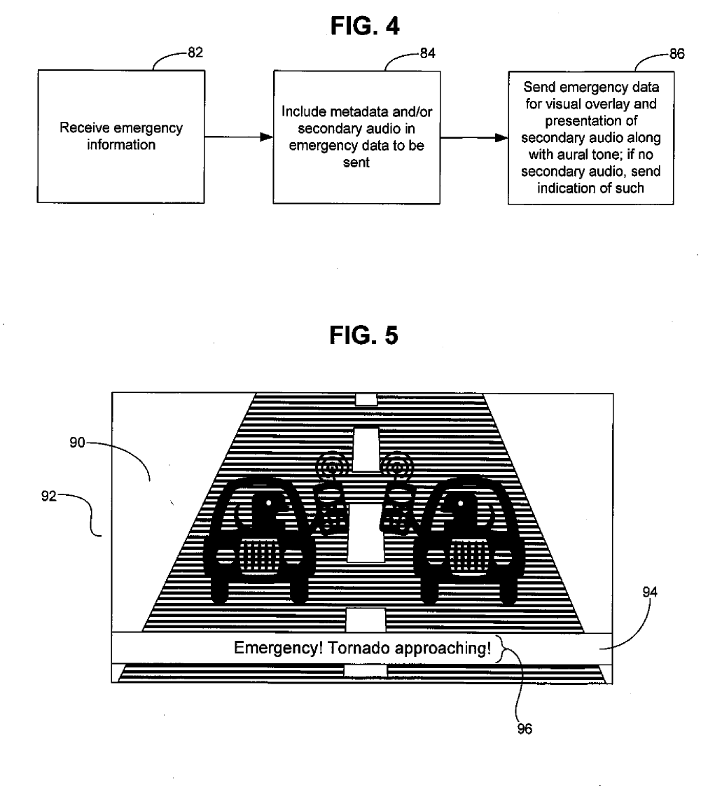

Now in reference to FIG. 4 is an exemplary flowchart of logic to be executed by a server and/or a head end (such as e.g. the server 46 or cable head end 54) for providing emergency alert information to one or more CE devices such as the CE device 12 is shown. Beginning at block 82, the logic receives or otherwise acquires emergency alert information to provide to CE devices. Such information may be received e.g. from a governmental agency, though it is to be understood that the emergency information may e.g. originate at the server or head end itself should it e.g. include weather detecting capabilities and make a determination that an emergency is occurring or is imminent.

Regardless, after block 82 the logic proceeds to block 84 where the logic includes in data and/or AV content to be provided to a CE device at least secondary audio regarding the emergency alert information (e.g. supplemental audio to be presented instead of audio of regularly scheduled AV content to also be provided), and/or additional metadata or information for visual presentation that similarly pertains to the emergency alert information. The logic then concludes at block 86 where the logic provides the secondary audio, metadata, and/or information for visual presentation to the CE device, along with an aural tone such as the aural tone described above in reference to FIG. 2. However, note that if for some reason the logic cannot provide the secondary audio or will not be able to provide it until a later time, an indication of such may be sent to the CE device instead (e.g. including data for audible and/or visual presentation of the indication). This indication may nonetheless be accompanied by the aural tone and other emergency alert information for visual overlay though it is to be understood that in some embodiments the indication alone may be provided. Additionally, note that the indication may in exemplary embodiments indicate that emergency alert information should be sought elsewhere as described above.

Continuing in reference to FIG. 5, an exemplary screen shot of video of AV content with an emergency alert overlaid thereon is shown. Thus, video 90 of a movie scene involving a car chase is shown on a display 92 of a CE device. Along a bottom portion of the display 92 is an emergency alert 94, and in this case it includes text 96 alerting a viewer that a tornado is approaching the location of the CE device (e.g., based on GPS coordinates from a GPS receiver on the CE device). The text 96 may in exemplary embodiments scroll on screen and off screen, left to right, although in addition to or in lieu of the scrolling the text 96 may e.g. blink or flash on and off such that it appears, then momentarily disappears, then reappears again. It may be appreciated that the alert 94 including the text 96 is presented on a relatively small portion of the display 92.

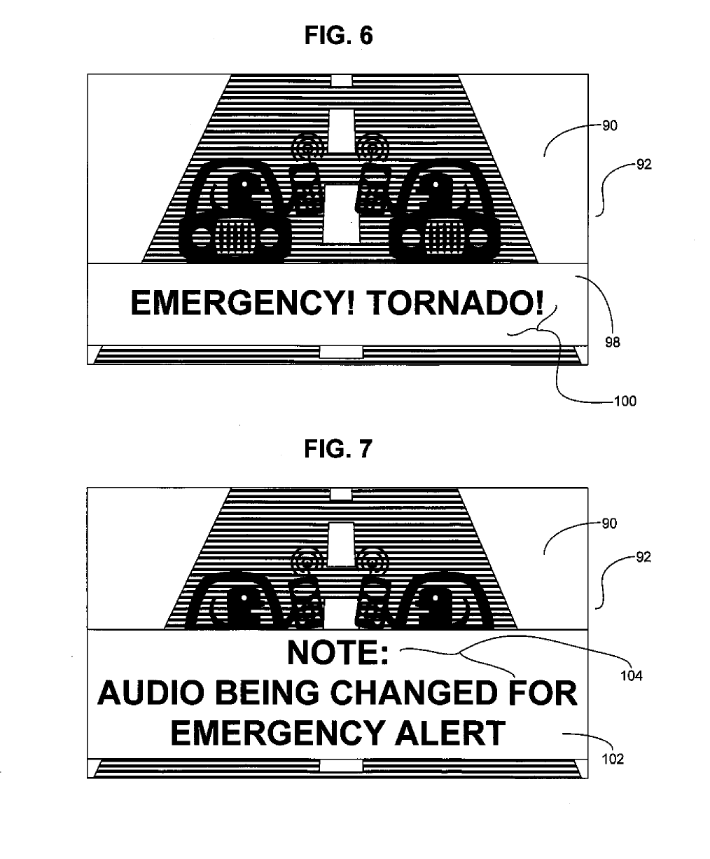

However, FIG. 6 again shows video 90 on the display 92, but instead an emergency alert 98 including text 100 that is presented larger than the alert 94 and text 96 of FIG. 5. The relatively larger emergency alert 98 and text 100 may be presented e.g. responsive to receiving emergency alert information when the CE device that has been set according to one or more visually impaired settings as described herein (and indeed it is to be understood that e.g. FIGS. 6-11 each show information presented when a CE device has been set according to one or more visually impaired settings). Still in reference to FIG. 6, it may be appreciated that the alert 98 is presented relatively larger in that the area of the display on which it is presented is larger in at least one dimension (e.g. in the present instance the height is greater) than an area on which the alert 94 is presented without any visually impaired settings being set to active. Also note that the text 100 is larger than the text 96 in at least one dimension but in the present instance the text 100 both consumes larger vertical and horizontal portions of the display 92.

Even further, owing to the larger presentation of emergency alert information as shown in FIG. 6, in some embodiments relatively less text may be presented (e.g. at any one time) than when an emergency alert is presented with CE device settings not set to active for one or more visually impaired settings. However, the essential emergency information is nonetheless conveyed. Specifically in regard to the alert 98, the fact that there is an emergency is conveyed by the exclamatory text “Emergency!” and the nature of the emergency is conveyed (e.g. the weather condition causing the emergency) by the exclamatory text “Tornado!” to indicate that there is a tornado in the area of the CE device. Regardless, note that relatively less text need not always be presented in all embodiments and e.g. the same or substantially the same text that would otherwise be presented when CE device settings are not set to active for one or more visually impaired settings may still be presented by e.g. scrolling the text on and off screen so that the text may still be presented relatively larger for a visually impaired viewer but nonetheless present all available emergency information.

Before moving on, it is to be understood that the emergency alerts of FIGS. 7-11 may be similar in configuration to the alert 98 of FIG. 6 (even though the text/information presented on the alerts may not be identical to the text 100) in that the presentation of such alerts and text may be in relatively larger dimensions based on e.g. the CE device having at least one of its visually impaired settings set to active and thus similar to the alert 98 in that the alerts described below may be easily discernable by a viewer with a visual impairment in accordance with present principles. Such alerts for the visually impaired as described further below will be referred to as visually impaired alerts.

Reference is now specifically made to FIG. 7, which again shows video 90 presented on the display 92. A visually impaired alert 102 is presented on the display 92 and includes text 104 indicating that audio (e.g. audio inputs) of the CE device is being changed from the audio associated with the AV content (in this case, the car chase AV content) to audio pertaining to an emergency alert in accordance with present principles. The alert 102 may be the first alert/information presented on the CE device automatically without user input responsive to the CE device receiving the alert information/metadata, or in other embodiments the alert 102 may be presented automatically without user input after a threshold time has elapsed of presentation for the alert 98 prior to presentation of the alert 102.

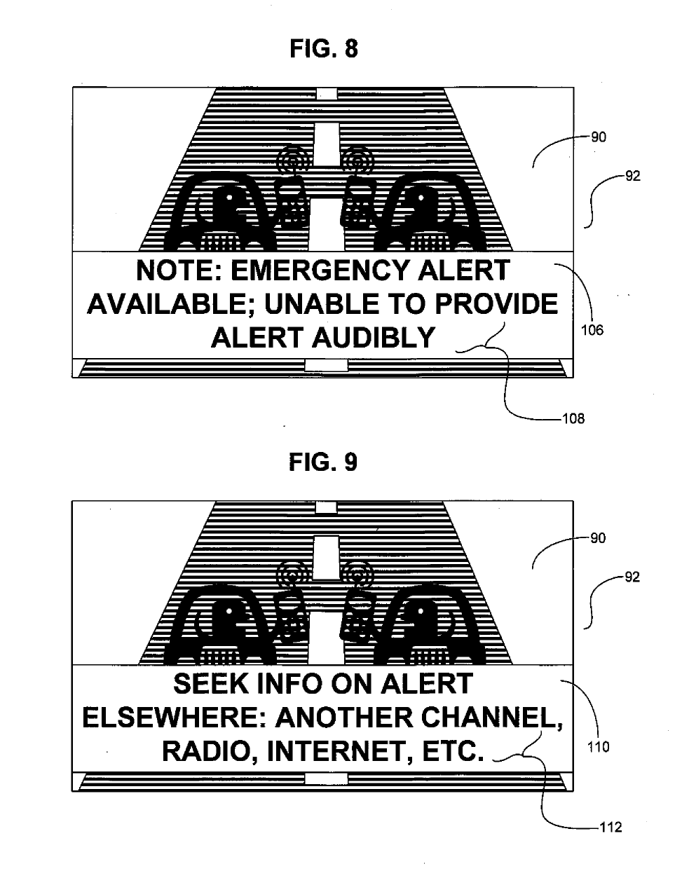

Now describing FIG. 8, video 90 is again presented on the display 92. A visually impaired alert 106 is presented on the display 92 and includes text 108 indicating that an emergency alert and/or information pertaining to an emergency is available but cannot be provided at least audibly (and/or visually) on the CE device and in some embodiments the text 108 may indicate that the alert/information cannot provided both visually or audibly. The alert 106 may be the first alert and/or information presented on the CE device automatically without user input responsive to the CE device receiving the alert information/metadata, or in other embodiments the alert 106 may be presented automatically without user input after a threshold time has elapsed of presentation of the alerts 98 and/or 102 (e.g. in sequence) prior to presentation of the alert 106.

Turning to FIG. 9, video 90 is presented on the display 92. A visually impaired alert 110 is presented on the display 92 and includes text 112 indicating that information regarding the emergency alert/information should be sought elsewhere in accordance present principles, and in some embodiments the text 112 may provide examples of and/or other suitable avenues for acquiring the alert/information such as e.g. tuning to a different channel to locate emergency alert/information for presentation on the CE device using the different channel (e.g. either or both by tuning to a live news cast or presentation of alert information in accordance with present principles that is multiplexed or otherwise included in the different channel's stream), tuning to a radio station using an AM/FM radio and indeed even an XM radio, and/or acquiring the information using the Internet (e.g. navigating to a news website or government emergency website). The alert 110 may be the first alert and/or information presented on the CE device automatically without user input responsive to the CE device receiving the alert information/metadata, or in other embodiments the alert 110 may be presented automatically without user input after a threshold time has elapsed of presentation of the alerts 98, 102, and/or 106 (e.g. in sequence) prior to presentation of the alert 110.

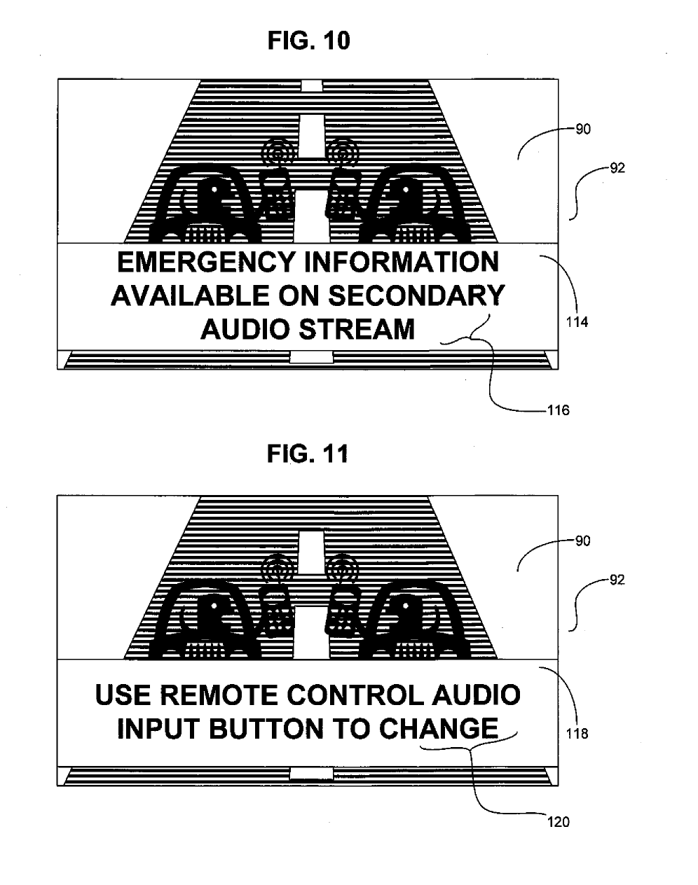

FIG. 10 again shows video 90 presented on the display 92. A visually impaired alert 114 is also shown in FIG. 10 and includes text 116 indicating that emergency alert/information is available on a secondary audio stream in accordance with present principles. The alert 114 may be the first alert and/or information presented on the CE device automatically without user input responsive to the CE device receiving the alert information/metadata, or in other embodiments the alert 114 may be presented automatically without user input after a threshold time has elapsed of presentation of the alerts 98, 102, and/or 110 (e.g. in sequence) prior to presentation of the alert 114.

FIG. 11 similarly shows video 90 on the display 92, and further includes a visually impaired alert 118 including text 120 indicating that a remote control/commander audio input button may be manipulated to change to e.g. a secondary audio stream as indicated in e.g. the alert 114 if the alert 114 was presented (e.g. in sequence) prior to the alert 118. Thus, the alert 118 may be presented automatically without user input after a threshold time has elapsed of presentation of the alerts 98, 102, 110 and/or 114 (e.g. in sequence) prior to presentation of the alert 118. However, it is to be understood that in some embodiments the alert 118 may be the first alert and/or information presented on the CE device automatically without user input responsive to the CE device receiving the alert information/metadata.

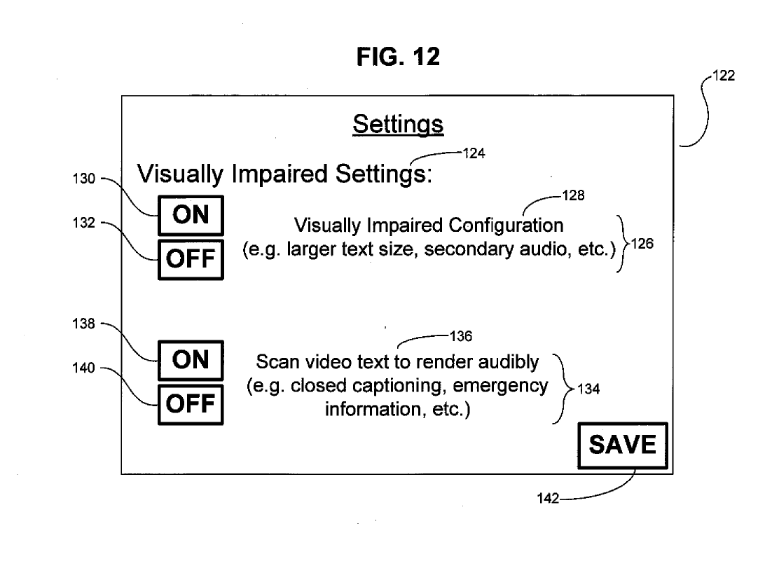

Before describing FIG. 12, it is to be understood that any and/or all of the text contained in the alerts 64, 98, 102, 108, 110, 114, and 118 may be combined with each other in various embodiments in accordance with present principles, may blink to attract the attention of a user, and/or may be presented in various highlighting or fonts that attract the attention of a user (e.g. such as red), etc. Accordingly, the alerts 64, 98, 102, 108, 110, 114, and 118 are understood to be exemplary.

Concluding the detailed description in reference to FIG. 12, a visually impaired settings UI 122 is shown, it being configured for manipulation by a user to set one or more visually impaired settings to active in accordance with present principles. Examples of such settings include but are not limited to font size selection options (larger for visually impaired), contrast enhancements (e.g., the use of black and white contrast in lieu of color), the use of white or black background for visually impaired viewers instead of a gray color, etc.

The UI 122 may constitute its own, separate UI or may form a portion of a CE device settings UI including settings options for non-visually impaired-related functions in some exemplary embodiments. Regardless, the exemplary UI 122 includes text 124 indicating that what is presented below the text 114 pertains to visually impaired settings for the CE device on which the settings UI 122 is presented. At least a first setting 126 is shown on the UI 122, the first setting 126 pertaining to a visually impaired configuration for presentation of content on the CE device such as e.g. presenting the content in a relatively larger text size more easily discernable to a person with a visual impairment, whether secondary audio should be automatically changed to upon receipt of emergency alert information in accordance with present principles (as indicated by text 128), etc. Thus, an on selector 130 and an off selector 132 are each presented and are selectable to configure the setting 126 to either active or inactive, respectively.

Also shown on the UI 122 is a second setting 134 that pertains to scanning text presented in video to present the information contained in the text and/or the text itself (such as e.g. closed captioning text, scrolling emergency information that is scanned as it scrolls on screen, etc.) audibly on the CE device (as indicated by the text 136). An on selector 138 and an off selector 140 are each presented and are selectable to configure the setting 134 to either active or inactive, respectively. Last, note that a save selector 142 is presented on the UI 122 that is selectable to save a user's configuration of the settings 126 and 134.

With no particular reference to any figure, it may now be appreciated that present principles provide methods, systems, and apparatuses for conveying emergency alerts and/or information to visually impaired users of CE devices such as HDTVs without e.g. requiring a user to “fumble” with a remote commander to gain better access to such information and/or change CE device settings during an emergency to listen to emergency-related audio when time may be of the essence. Furthermore, present principles recognize that “secondary audio” including such emergency alerts/information may be presented on a CE device automatically without receiving user input to change from the first audio to the second audio subsequent to receiving the data associated with the emergency alert. If desired, the alerts/information may include both audio data for presenting the secondary audio on the CE device and metadata which, when received by the CE device, at least in part causes and/or triggers the CE device processor to change to the second audio. Also if desired, the alert/information may be automatically visually overlaid on video of AV content responsive to receiving the alert/information without any user input to present and/or overlay the alert/information. In embodiments where the alert/information is visually overlaid onto video and/or scanned for audible presentation, a determination may be made that the visual overlay and/or scrolling/crawling information pertains to an emergency alert before audibly presenting the alert/information (e.g., by comparing the visually presented information to a database of key words related to emergencies stored locally on the CE device triggering a determination that the alert/information indeed pertains to an emergency alert).

Also note that the second/secondary audio described herein that pertains to emergency alerts/information rather than to audio of AV content may be presented separately in that audio from the AV content is not presented (e.g. is muted), or it may be presented along with the AV content's audio (e.g., but with the secondary audio being presented at a greater volume than audio of the AV content). For completeness, present principles further recognize that although the foregoing description sometimes makes reference to something occurring responsive to receipt of the emergency alert and/or information, present principles nonetheless recognize that the same things that are executed responsive to receipt of the alerts/information may also or alternatively be executed responsive to receipt of (e.g. only) an aural tone as described herein (e.g., in instances where an aural tone is received at a time prior to receiving the alert/information itself).

While the particular AUTOMATIC SWITCHING FROM PRIMARY TO SECONDARY AUDIO DURING EMERGENCY BROADCAST is herein shown and described in detail, it is to be understood that the subject matter which is encompassed by the present invention is limited only by the claims.

What is claimed is:

1. An audio video device (AVD), comprising:
a processor configured for controlling a display;
at least one computer readable storage medium that is not a carrier wave and that is accessible to the processor, the computer readable storage medium bearing instructions which when executed by the processor cause the processor to:
present, on the display, audio video (AV) content, the AV content not being associated with information pertaining to a current emergency or imminent emergency;
receive, at the device, data associated with an emergency alert; and
responsive to receiving the data associated with the emergency alert, change audio presented on the display from first audio presented on the display and associated with the AV content to second audio associated with the data associated with the emergency alert to present the second audio;
wherein the second audio is presented on the display automatically without receiving user input to change from the first audio to the second audio subsequent to receiving the data associated with the emergency alert.

2. The AVD of claim 1, wherein video of the AV content is presented on the display subsequent to changing to the second audio.

3. The AVD of claim 1, wherein the second audio includes an aural tone, the aural tone indicating emergency information will be presented on the display.

4. The AVD of claim 1, wherein the instructions further cause the processor to, responsive to receiving the data associated with the emergency alert, overlay on video of the AV content emergency information associated with the emergency alert.

5. The AVD of claim 4, wherein the emergency information is text scrolling across a portion of the display.

6. The AVD of claim 1, wherein the data includes both audio data for presenting the second audio on the display and metadata which, when received by the AVD, at least in part causes the processor to change to the second audio.

7. The AVDD of claim 1, wherein audio is changed to the second audio responsive to receiving the data associated with the emergency alert only if, prior to receiving the data, a setting associated with the AVD to change to the second audio upon receiving data associated with an emergency alert has been set to active.

8. A method, comprising:
presenting, on a device, audio video (AV) content, the AV content not being associated with information pertaining to an emergency;
receiving data pertaining to a current emergency or imminent emergency;
responsive to a determination that the data does not include data for causing an audio indication of the emergency to be presented on the device, at least visually presenting on the device an indication that information regarding an emergency is available;
responsive to a determination that the data does include data for causing an audio indication of the emergency to be presented on the device, audibly presenting the audio indication on the device at least in part using on the received data.

9. The method of claim 8, wherein responsive to the determination that the data does include data for causing an audio indication of the emergency to be presented on the device, audibly presenting on the device at least in part using on the received data the audio indication and also visually presenting on the device at least in part using on the received data a visual indication that information regarding an emergency is available.

10. The method of claim 8, wherein the audio indication is preceded by an aural tone, the aural tone indicating emergency information is about to be presented on the device.

11. The method of claim 8, wherein responsive receiving the data pertaining to a current emergency or imminent emergency and regardless of whether the data includes data for causing an audio indication of the emergency to be presented on the device, presenting an aural tone indicating that emergency information for a current and/or imminent emergency is available for observation by a user of the device.

12. The method of claim 8, wherein responsive to the determination that the data does include data for causing the audio indication of the emergency to be presented on the device, changing audio configurations of the device from a first audio configuration to a second audio configuration to audibly present the audio indication using the second audio configuration, the first audio configuration configured for presenting audio associated with the AV content, the second audio configuration configured at least for presenting the audio indication, the second audio configuration configured for not presenting audio associated with the AV content.

13. The method of claim 8, wherein the indication visually presented on the device responsive to the determination that the data does not include data for causing the audio indication of the emergency to be presented on the device further indicates that information pertaining to the emergency should be sought by taking action other than manipulation of the device to access the information.

14. A computer readable storage medium that is not a carrier wave, the computer readable storage medium bearing instructions which when executed by a processor of a device configure the processor to execute logic comprising:
presenting audio video (AV) content on a display, the AV content not pertaining to a current or imminent emergency;
receiving first data at the device, the first data including at least information for visual overlay on at least a portion of the video of the AV content, the information for visual overlay pertaining a current or imminent emergency; and
converting the first data into second data, the second data useful for audio presentation of the information.

15. The computer readable storage medium of claim 14, wherein the instructions when executed by a processor further configure the processor for audibly presenting the information using the second data.

16. The computer readable storage medium of claim 15, wherein the instructions when executed by a processor further configure the processor for audibly presenting the information at least in part by changing audio configurations of the display from a first audio configuration to a second audio configuration to audibly present the information using the second audio configuration, the first audio configuration configured for presenting the audio of the AV content, the second audio configuration configured for presenting the information and for not presenting the audio of the AV content.

17. The computer readable storage medium of claim 14, wherein the instructions when executed by a processor further configure the processor for automatically visually overlaying the information on at least a portion of the video of the AV content responsive to receiving the information, the first data being converted to the second data at least partially by scanning the information overlaid on the AV video of the AV content to extract the second data therefrom.

18. The computer readable storage medium of claim 17, wherein the instructions when executed by a processor further configure the processor for audibly presenting the information, and wherein the information is audibly presented at least in part by changing audio configurations of the display from a first audio configuration to a second audio configuration to audibly present the information using the second audio configuration, the first audio configuration configured for presenting the audio of the AV content, the second audio configuration configured for presenting the information and for not presenting the audio of the AV content.

19. The computer readable storage medium of claim 17, wherein the information is visually overlaid on a portion of the video of the AV content such that it scrolls on and off the display.

20. The computer readable storage medium of claim 19, wherein information is scanned as it scrolls on the display.
